(19) United States
(12) Patent Application Publication
(10) Pub. No.: US 2012/0238326 A1
(43) Pub. Date: Sep. 20, 2012

(54) ELECTRONIC APPARATUS

(75) Inventors: Masatomo MORI, Kawasaki (JP); Hiroyuki TAKITA, Kawasaki (JP); Takashi SUZUKI, Kawasaki (JP)

(73) Assignee: FUJITSU LIMITED, Kawasaki-shi (JP)

(21) Appl. No.: 13/413,539

(22) Filed: Mar. 6, 2012

(30) Foreign Application Priority Data
Mar. 18, 2011 (JP) 2011-061768

(51) Int. Cl. H01Q 1/24; H04W 88/02

(52) U.S. Cl. 455/566; 343/702

(57) ABSTRACT

An electronic apparatus includes a housing, a circuit board housed in the housing and an antenna including a proximal end portion connected to the circuit board and extending beyond an edge of the circuit board. The housing includes a recess depressed in a direction away from the edge of the circuit board, the recess being formed in a part of the housing facing the edge of the circuit board. The antenna is housed in the recess.

### CROSS-REFERENCE TO RELATED APPLICATIONS

This application is based upon and claims the benefit of priority from the prior Japanese Patent Application No.2011-061768 filed on Mar. 18, 2011, the entire contents of which are incorporated herein by reference.

### FIELD

The embodiment(s) discussed herein is (are) related to an electronic apparatus.

### BACKGROUND

An electronic apparatus which is able to maintain a waterproof property has been known. In this type of electronic apparatus, a circuit board on which various electronic components are mounted is housed in a housing in a watertight manner. Of the electronic components mounted on the circuit board, an antenna is preferably located away from the other electronic components on the circuit board in order to curb the influence of the antenna on the other electronic components.

Japanese Laid-open Patent Publication No. 2008-11116 is an example of a conventional art apparatus which proposes an electronic apparatus in which the distal end portion of an antenna is disposed between an inner housing that houses a circuit board and an outer housing that covers the inner housing. In this electronic apparatus, only a feeding portion that is the proximal end portion of the antenna is pulled through a hole provided in the inner housing into the inside of the inner housing and is connected to the circuit board, and the distal end portion of the antenna is thereby disposed away from the other electronic components on the circuit board. The influence of the radio waves from the distal end portion of the antenna on the other electronic components can thereby be curbed.

However, in the above-described conventional art apparatus, although the influence of the antenna on the other electronic components can be curbed while maintaining the waterproof property, there is a problem because the size of the electronic apparatus is increased.

Specifically, in the electronic apparatus of the conventional art, a double structure in which an outer housing is joined to an inner housing is used, and a space for disposing the distal end portion of an antenna is formed between the inner housing and the outer housing. For this reason, the electronic apparatus of the conventional art is increased in size by the space formed between the inner housing and the outer housing along with the additional space required by the outer housing.

### SUMMARY

According to an aspect of the invention, an electronic apparatus includes a housing, a circuit board housed in the housing and an antenna including a proximal end portion connected to the circuit board and extending beyond an edge of the circuit board. The housing includes a recess depressed in a direction away from the edge of the circuit board, the recess being formed in a part of the housing facing the edge of the circuit board. The antenna is housed in the recess.

The object and advantages of the various embodiments will be realized and attained by means of the elements and combinations particularly pointed out in the claims. It is to be understood that both the foregoing general description and the following detailed description are exemplary and explanatory and are not restrictive of the various embodiments, as claimed.

Additional aspects and/or advantages will be set forth in part in the description which follows and, in part, will be apparent from the description, or may be learned by practice of the various embodiments.

### BRIEF DESCRIPTION OF DRAWINGS

FIG. 1 is an external perspective view illustrating a closed state of a cellular phone;

FIG. 2 is an external perspective view illustrating an open state of the cellular phone;

FIG. 3 is an external perspective view illustrating a rotated state of the cellular phone;

FIG. 4 is an exploded perspective view of the cellular phone;

FIG. 5 is a plan view of a fixed-side housing as viewed from the side of a fixed-side rear case;

FIG. 6 is an exploded perspective view of the fixed-side housing;

FIG. 7 is a sectional view of the fixed-side housing illustrated in FIG. 5 taken along line VII-VII of FIG. 5; and

FIG. 8 is a sectional view of the fixed-side housing illustrated in FIG. 5 taken along line VIII-VIII of FIG. 5.

### DESCRIPTION OF EMBODIMENTS

Hereinafter, an embodiment of the electronic apparatus disclosed by this application will be described with reference to the drawings. Although the following embodiment illustrates a cellular phone as an example of the electronic apparatus disclosed by this application, the electronic apparatus disclosed by this application may be any one of various electronic apparatuses other than a cellular phone, such as a personal computer, a PDA (Personal Digital Assistant), a portable game machine or the like.

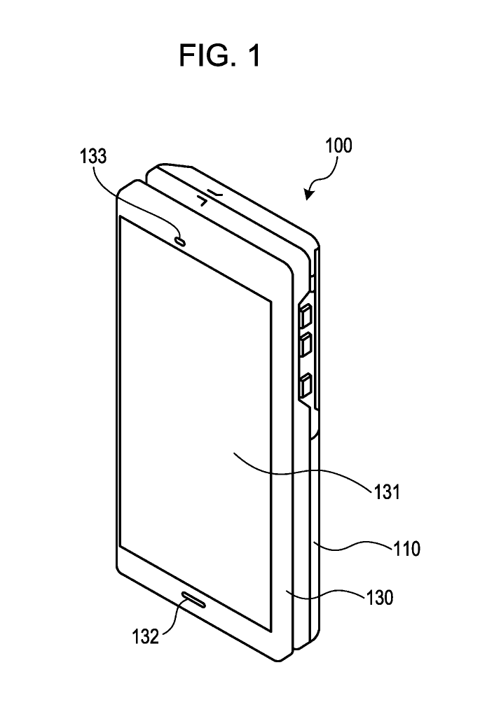

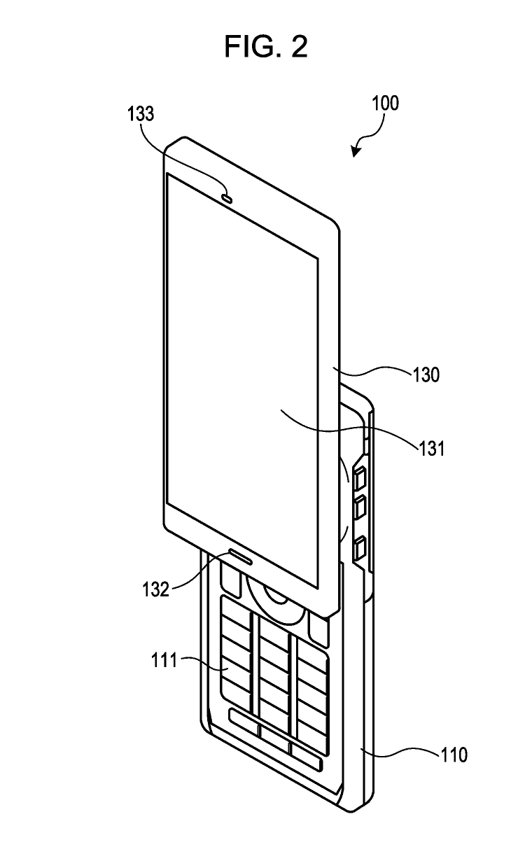

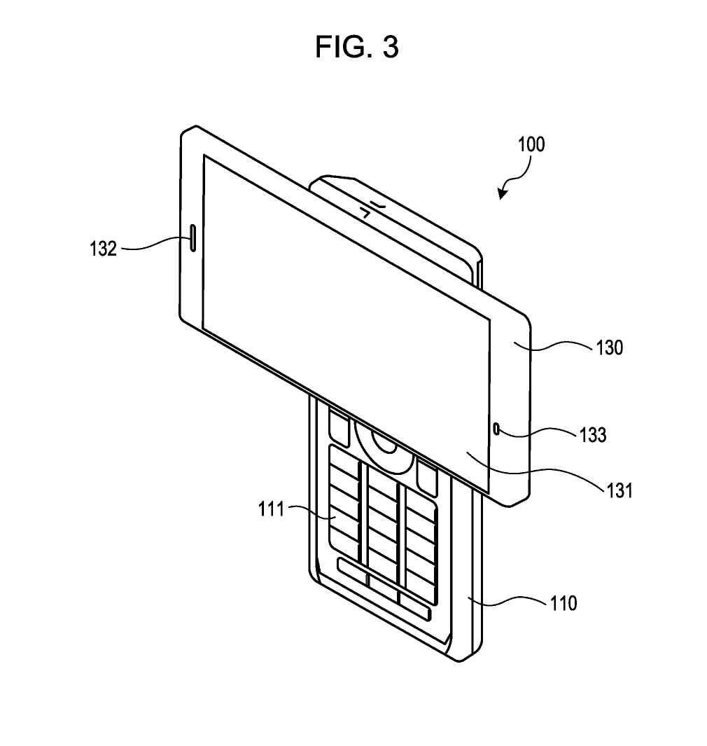

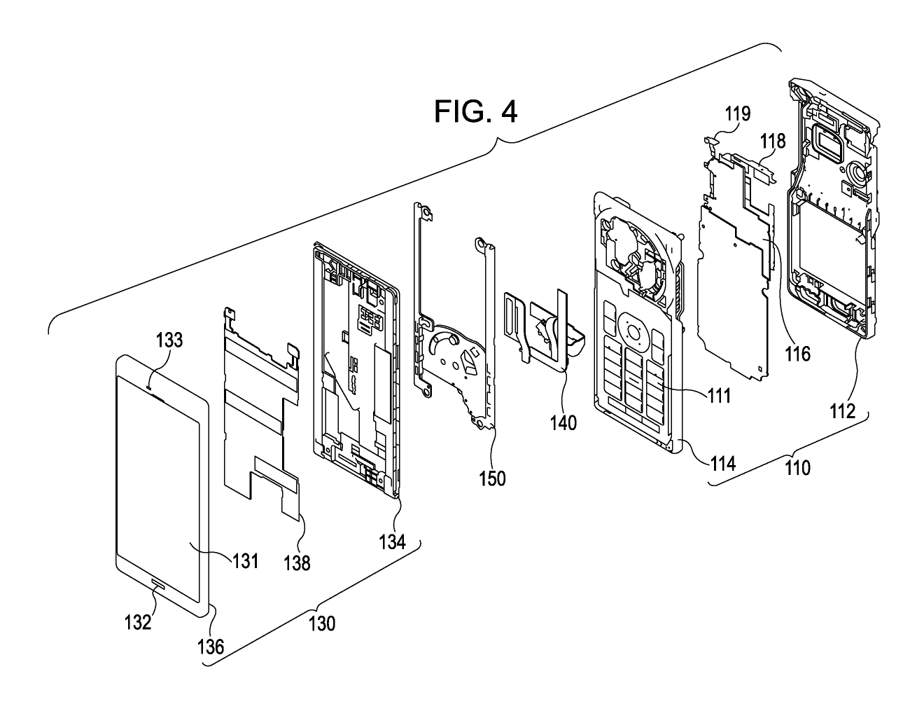

First, the configuration of the cellular phone 100 according to this embodiment will be described with reference to FIGS. 1-4. FIG. 1 is an external perspective view illustrating a closed state of the cellular phone 100. FIG. 2 is an external perspective view illustrating an open state of the cellular phone 100. FIG. 3 is an external perspective view illustrating a rotated state of the cellular phone 100. FIG. 4 is an exploded perspective view of the cellular phone 100.

As illustrated in FIGS. 1-3, the cellular phone 100 includes a fixed-side housing 110 and a movable-side housing 130. The fixed-side housing 110 is a housing which includes an operating portion 111. The movable-side housing 130 is a housing which houses a display panel 131. The fixed-side housing 110 is provided with the operating portion 111 having operating buttons. The movable-side housing 130 is provided with the display panel 131, and a microphone 132 and a speaker 133 for verbal communication.

The fixed-side housing 110 and the movable-side housing 130 are coupled to each other while being able to move relative to each other by a coupling mechanism 150 illustrated in FIG. 4. By the sliding operation or rotating operation of the movable-side housing 130 relative to the fixed-side housing 110 using the coupling mechanism 150, the cellular phone 100 is able to change between the closed state illustrated in FIG. 1, the open state illustrated in FIG. 2, and the rotated state illustrated in FIG. 3.

The closed state illustrated in FIG. 1 is a state where the fixed-side housing 110 and the movable-side housing 130 overlap with the greatest area of overlap. In this closed state, the total length of the cellular phone 100 in the longitudinal direction is shortest. For this reason, the cellular phone 100 is set to the closed state, for example, when the user carries the cellular phone 100 or when the user uses a simple function executable without using the operating portion 111, such as the viewing of the history of calls.

The open state illustrated in FIG. 2 is a state where owing to the sliding operation of the movable-side housing 130 relative to the fixed-side housing 110, the fixed-side housing 110 and the movable-side housing 130 overlap with the smallest area of overlap. In this open state, the total length of the cellular phone 100 in the longitudinal direction is longest. In this open state, the operating portion 111 of the fixed-side housing 110 is exposed. For this reason, the cellular phone 100 is set to the open state, for example, during a call or when the user performs an operation using the operating portion 111, such as composing an e-mail message.

The rotated state illustrated in FIG. 3 is a state where the movable-side housing 130 is rotated 90 degrees with respect to the fixed-side housing 110. This rotated state is a state where the display panel 131 is horizontally long with respect to the fixed-side housing 110. For this reason, the cellular phone 100 is set to the rotated state, for example, when the user watches a video or browses a web page.

As illustrated in FIG. 4, the fixed-side housing 110 is formed by joining a fixed-side rear case 112 and a fixed-side front case 114. An operating portion 111 is disposed on the outer surface of the fixed-side front case 114 facing the movable-side housing 130. A fixed-side circuit board 116 and antenna members 118 and 119 are housed in an internal space between the fixed-side rear case 112 and the fixed-side front case 114. Various electronic components are mounted on the fixed-side circuit board 116. The antenna members 118 and 119 are connected to the fixed-side circuit board 116. The details of the internal configuration of the fixed-side housing 110 are described more fully below.

The movable-side housing 130 is formed by joining a movable-side rear case 134 and a movable-side front case 136. A display panel 131, a microphone 132, and a speaker 133 are disposed on the outer surface of the movable-side front case 136. A movable-side circuit board 138 is housed in an internal space between the movable-side rear case 134 and the movable-side front case 136. Various electronic components are mounted on the movable-side circuit board 138. The movable-side circuit board 138 is electrically connected to the fixed-side circuit board 116 by a connecting cable 140.

The coupling mechanism 150 is provided between the fixed-side housing 110 and the movable-side housing 130. The coupling mechanism 150 is a movable mechanism that combines a predetermined sliding mechanism and a predetermined rotating mechanism. The coupling mechanism 150 couples the fixed-side housing 110 and the movable-side housing 130 to each other slidably and rotatably.

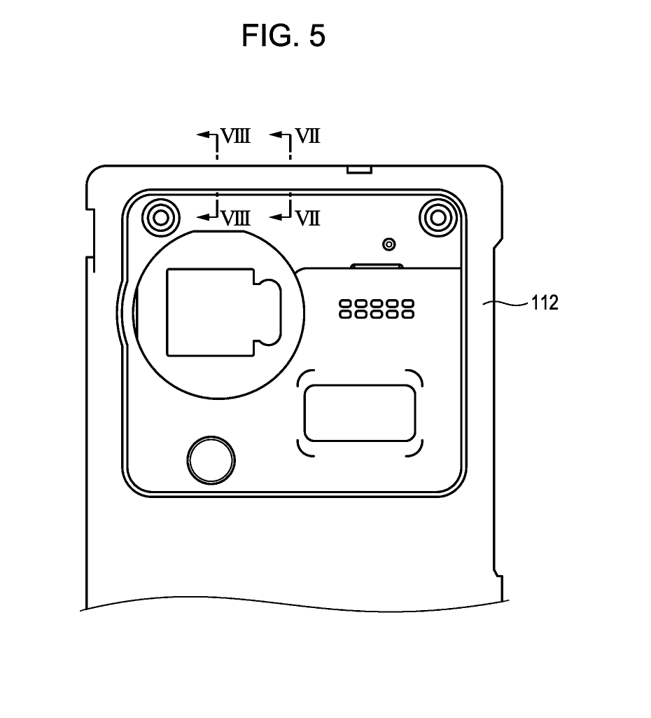

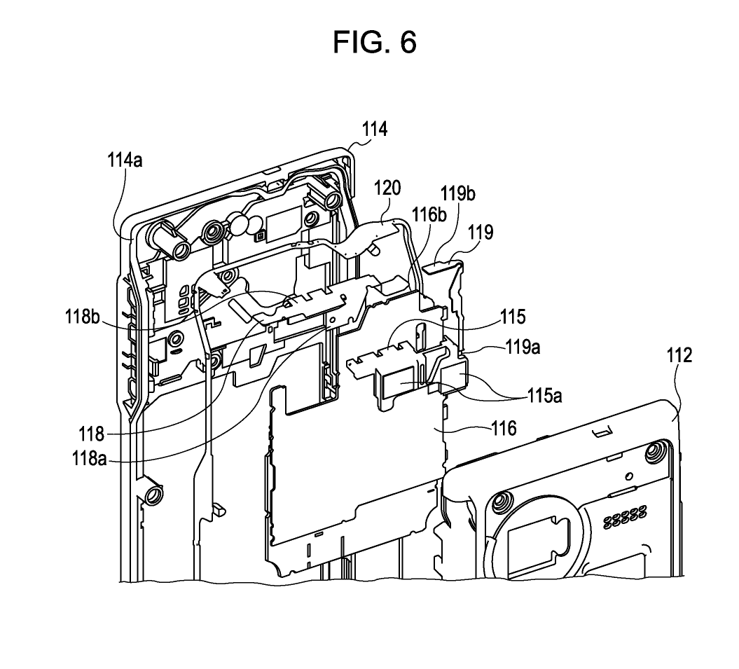

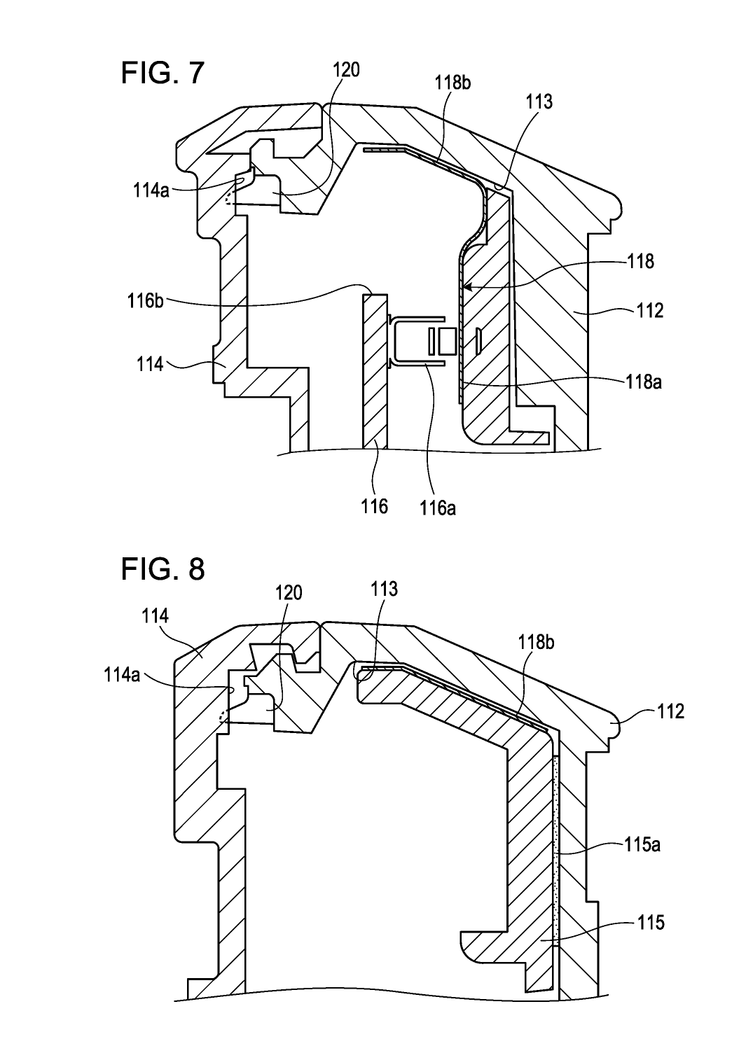

Next, the details of the internal configuration of the fixed-side housing 110 will be described. FIG. 5 is a plan view of the fixed-side housing 110 as viewed from the side of the fixed-side rear case 112. FIG. 6 is an exploded perspective view of the fixed-side housing 110. FIG. 7 is a sectional view of the fixed-side housing 110 illustrated in FIG. 5 taken along line VII-VII of FIG. 5. FIG. 8 is a sectional view of the fixed-side housing 110 illustrated in FIG. 5 taken along line VIII-VIII of FIG. 5. FIG. 7 illustrates a section passing through the proximal end portion 118a of the antenna member 118. FIG. 8 illustrates a section passing through the distal end portion 118b of the antenna member 118.

As illustrated in FIGS. 6-8, the fixed-side housing 110 is formed by joining the fixed-side rear case 112 and the fixed-side front case 114 with a waterproof gasket 120 therebetween. The waterproof gasket 120 is interposed between the top of the side wall of the fixed-side rear case 112 and the edge 114a of the fixed-side front case 114 and seals the gap between the top of the side wall of the fixed-side rear case 112 and the edge 114a of the fixed-side front case 114 in a watertight manner. This prevents water from entering the internal space of the fixed-side housing 110 between the fixed-side rear case 112 and the fixed-side front case 114.

A fixed-side circuit board 116 on which various electronic components are mounted is attached to the region on the inner side of the side wall of the fixed-side rear case 112. The gap between the top of the side wall of the fixed-side rear case 112 and the edge 114a of the fixed-side front case 114 is sealed in a watertight manner by the waterproof gasket 120. That is to say, the fixed-side circuit board 116 is housed in a watertight manner in the internal space of the fixed-side housing 110 between the fixed-side rear case 112 and the fixed-side front case 114.

As illustrated in FIG. 7, a spring terminal 116a is provided at a predetermined position on the surface of the fixed-side circuit board 116. The antenna member 118 is attached to the fixed-side circuit board 116 with the spring terminal 116a therebetween. The spring terminal 116a is provided on the fixed-side circuit board 116 so as to correspond to the antenna members 118 and 119. FIG. 7 illustrates a state where the antenna member 118 is attached to the fixed-side circuit board 116 with the spring terminal 116a therebetween.

The antenna members 118 and 119 are antennas used for communication of different frequencies. For example, the antenna member 118 is used for communication of 800 MHz, and the antenna member 119 is used for communication of 2 GHz. The antenna members 118 and 119 are formed of a flexible material. The proximal ends 118a and 119a of the antenna members 118 and 119 are connected to the spring terminal 116a of the fixed-side circuit board 116, and the distal ends 118b and 119b of the antenna members 118 and 119 extend in the internal space of the fixed-side housing 110 so as to cross the edge 116b of the fixed-side circuit board 116.

As illustrated in FIGS. 7-8, the fixed-side rear case 112 includes a recess 113 depressed in a direction away from the edge 116b of the fixed-side circuit board 116, in a part of the side wall facing the edge 116b of the fixed-side circuit board 116. A recess 113 houses a distal end portion 118b of the antenna member 118 extending beyond the edge 116b of the fixed-side circuit board 116. The distal end portion 118b of the antenna member 118 housed in the recess 113 and the surface of the recess 113 may be bonded with double-sided tape or the like. Although not illustrated, the recess 113 houses the distal end portion 119b of the antenna member 119 extending beyond the edge 116b of the fixed-side circuit board 116.

As illustrated in FIGS. 6-8, the fixed-side rear case 112 includes a pressing member 115 that presses the distal end portion 118b of the antenna member 118 housed in the recess 113 toward the recess 113. The pressing member 115 is attached to the fixed-side rear case 112 with double-sided tape 115a. This prevents the distal end portion 118b of the antenna member 118 from moving away from the recess 113 and approaching the fixed-side circuit board 116.

Although this embodiment illustrates an example in which the distal end portions 118b and 119b of the antenna members 118 and 119 are housed in the recess 113, the present invention is not limited to this configuration. For example, in the case where the antenna members 118 and 119 extend in a direction away from the edge 116b of the fixed-side circuit board 116, are housed in the recess 113, and then bend toward the edge 116b of the fixed-side circuit board 116, instead of the distal end portions 118b and 119b of the antenna members 118 and 119, other parts of the antenna members 118 and 119 may be housed in the recess 113.

As described above, in the cellular phone 100 of this embodiment, a fixed-side circuit board 116 is housed in a watertight manner in a fixed-side housing 110 formed by joining a fixed-side rear case 112 and a fixed-side front case 114. For this reason, according to this embodiment, the waterproof property of the fixed-side circuit board 116 is maintained. In the cellular phone 100 of this embodiment, the fixed-side rear case 112 includes a recess 113 depressed in a direction away from the edge 116b of the fixed-side circuit board 116. The recess 113 is formed in a part of the side wall facing the edge 116b of the fixed-side circuit board 116. In the cellular phone 100 of this embodiment, the distal end portion 118b of the antenna member 118 extending beyond the edge 116b of the fixed-side circuit board 116 is housed in the recess 113. For this reason, according to this embodiment, the distal end portion 118b of the antenna member 118 is disposed a predetermined distance away from the other electronic components on the fixed-side circuit board 116, and the influence of the radio waves from the distal end portion 118b of the antenna member 118 on the other electronic components is curbed. According to this embodiment, it is not necessary to join an outer housing covering the fixed-side housing 110 to the fixed-side housing 110 and to form a space for disposing the antenna members between the fixed-side housing 110 and the outer housing, and therefore the cellular phone 100 is reduced in size. That is to say, according to this embodiment, the waterproof property is maintained, the influence of the antenna member 118 on the other electronic components on the fixed-side circuit board 116 is curbed, and the cellular phone 100 is reduced in size.

The cellular phone 100 of this embodiment includes a pressing member 115 that presses the distal end portion 118b of the antenna member 118 housed in the recess 113 of the fixed-side rear case 112 toward the recess 113. For this reason, according to this embodiment, in the case where unexpected external force acts on the distal end portion 118b of the antenna member 118 owing to drop shock or the like, the distal end portion 118b of the antenna member 118 is prevented from moving away from the recess 113 and approaching the fixed-side circuit board 116. As a result, according to this embodiment, even in the case where an unexpected situation such as a drop occurs, the influence of the antenna member 118 on the other electronic components on the fixed-side circuit board 116 is curbed.

In the cellular phone 100 of this embodiment, the distal end portion 118b of the antenna member 118 housed in the recess 113 of the fixed-side rear case 112 and the surface of the recess 113 may be bonded with double-sided tape or the like. For this reason, according to this embodiment, the force moving the distal end portion 118b of the antenna member 118 away from the recess 113 is reduced by the adhesive force between the distal end portion 118b of the antenna member 118 and the surface of the recess 113. As a result, according to this embodiment, the distal end portion 118b of the antenna member 118 is prevented from moving away from the recess 113 and approaching the fixed-side circuit board 116 while maintaining a simple configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An electronic apparatus comprising:
a housing;
a circuit board housed in the housing; and
an antenna including a proximal end portion connected to the circuit board and extending beyond an edge of the circuit board,
wherein the housing includes a recess depressed in a direction away from the edge of the circuit board, the recess being formed in a part of the housing facing the edge of the circuit board, and
wherein the antenna is housed in the recess.

2. The electronic apparatus according to claim 1, further comprising a pressing member which presses the antenna member housed in the recess toward the recess.

3. The electronic apparatus according to claim 1, wherein the antenna member is bonded to the surface of the recess.

4. The electronic apparatus according to claim 1, wherein the circuit board is housed in the housing in a watertight manner.

5. The electronic apparatus according to claim 4, wherein the housing comprises a fixed-side rear case and a fixed-side front case, the circuit board being housed between the fixed-side rear case and the fixed-size front case, and wherein the housing further comprises a waterproof gasket which seals the circuit board within the fixed-side rear case and fixed-side front case in a watertight manner.

6. The electronic apparatus according to claim 1, wherein the proximal end portion of the antenna is connected to a spring terminal of the circuit board, and wherein a distal end portion of the antenna extending beyond the edge of the circuit board is housed in the recess.

7. A cellular phone comprising:
a housing including a display panel and an operating portion;
a circuit board housed in the housing for controlling the display panel and the operating portion, the circuit board being housed in the housing in a watertight manner; and
an antenna including a proximal end portion connected to the circuit board and extending beyond an edge of the circuit board,
wherein the housing includes a recess depressed in a direction away from the edge of the circuit board, the recess being formed in a part of the housing facing the edge of the circuit board, and
wherein the antenna is housed in the recess.

8. The cellular phone according to claim 7, further comprising a pressing member which presses the antenna member housed in the recess toward the recess.

9. The cellular phone according to claim 7, wherein the antenna member is bonded to the surface of the recess.

10. The cellular phone according to claim 7, wherein the housing comprises a fixed-side rear case and a fixed-side front case, the circuit board being housed between the fixed-side rear case and the fixed-side front case, and wherein the housing further comprises a waterproof gasket which seals the circuit board within the fixed-side rear case and fixed-side front case in a watertight manner.

11. The cellular phone according to claim 7, wherein the proximal end portion of the antenna is connected to a spring terminal of the circuit board, and wherein a distal end portion of the antenna extending beyond the edge of the circuit board is housed in the recess.
